(19) United States
(12) Patent Application Publication
(10) Pub. No.: US 2016/0163235 A1
(43) Pub. Date: Jun. 9, 2016

(54) Can End Label

(71) Applicant: Avery Dennison Corporation, Glendale, CA (US)

(72) Inventors: Peter J. HEEDERIK, Hillegom (NL); Edwin VAN DELFT, Oegstgeest (NL); Dustie MILLER, Lakeline, OH (US); Mitchell J. RACKOVAN, Madison, OH (US); Gregory P. BRUMBAUGH, Hudson, OH (US)

(21) Appl. No.: 14/564,245

(22) Filed: Dec. 9, 2014

(51) Int. Cl. G09F 3/10; B32B 37/10; B32B 37/06; B65D 1/12; B32B 7/12; B32B 27/08; B32B 27/34; B32B 37/00; B32B 38/10

(52) U.S. Cl. CPC G09F 3/10; B32B 37/025; B32B 37/1018; B32B 37/06; B32B 38/10; B32B 7/12; B32B 27/08; B32B 27/34; B65D 1/12; B32B 2307/31; B32B 2519/00; G09F 2003/0272

(57) ABSTRACT

Labels configured for application to ends of beverage cans are described. The labels may include various decorations or indicia. The labels are removable from the can end and include a layer of adhesive. In certain versions, the labels are sized and shaped prior to their application to thereby match the contour of the can end of interest.

### FIELD

The present subject matter relates to labels for can ends, and methods for labeling can ends. The subject matter also relates to cans having labels or other thin material layers applied to their ends.

### BACKGROUND

Food and beverage cans are typically cylindrical in shape and include provisions for opening the can to gain access to its contents. Typically, the opening provisions are in the form of a tab which is affixed to an end of the can and located adjacent to a section of weakened or scored material. Upon actuating the tab such as by pulling away from the can end, an opening is formed in the can end in the shape of the weakened section. This configuration is well known and used throughout the world in various forms.

Artisans have devised various covers, films, and labels for application onto can ends. These covers, films, and labels have been provided for various purposes including protecting the can end from contamination or accumulation of dirt, retaining items such as promotional articles along the can end, or for providing decoration or information associated with the can, its supplier, and/or the contents of the can.

A problem associated with previously known can end covers is poor retention between the cover and the can end. Although attaching covers and the like to can ends by use of an adhesive is known, in order to enable the cover to be easily removed by a consumer, the adhesive must be designed so as to not overly adhere the cover to the can end or else cover removal will be difficult. And, if the adhesive does not sufficiently adhere the cover to the can end, the cover may become detached or otherwise separate prematurely from the can end. In view of these and other problems, artisans have devised covers that mechanically or frictionally attach to a can end. A problem associated with certain can end covers that mechanically engage with a circular lip extending around the periphery of a can end, is that such covers must be manufactured with relatively high tolerances. That in turn typically involves increased manufacturing costs of the cover. Accordingly, a need exists for a cover that is economical and which exhibits improved retention to a can end using ready available adhesives.

### SUMMARY

The difficulties and drawbacks associated with previously known can end covers are addressed by the present subject matter.

In one aspect, the present subject matter provides a can end label comprising a first polymeric layer defining an outer face and an inner face, and a second polymeric layer defining an outer face and an inner face. The can end label also comprises a first adhesive layer defining an inner face for contacting a can end, and a second adhesive layer disposed between the first polymeric layer and the second polymeric layer.

In another aspect, the present subject matter also provides a can end label comprising a polymeric base film defining an outer face and an inner face, an adhesive layer extending along the inner face of the polymeric base film, and an overlam lacquer layer disposed on the polymeric base film.

In still another aspect, the present subject matter provides a labeled can comprising a can defining a first end, a second end opposite from the first end, and at least one sidewall extending between the first and the second ends. The labeled can also comprises a can end label as described herein which is removably attached to at least one of the first end and the second end of the can.

In yet another aspect, the present subject matter provides a method of forming a can end label adapted for placement on a can end. The method comprises providing a can end label, and providing a can end die defining a contoured die surface corresponding to the can end of interest. The method also comprises applying the can end label to the can end die, and transferring a contour of the die surface to the can end label to thereby form a configured can end label adapted for placement on the can end.

In an additional aspect, the present subject matter provides a method for reducing a potential for contamination from contacting an outer surface of a beverage can upon drinking a liquid from the can. The method comprises providing a sealed beverage can containing a liquid. The can includes a circular end having a removable tab, and a circumferential sidewall. The method also comprises selecting either (i) a can end label including a first polymeric layer defining an outer face and an inner face, a second polymeric layer defining an outer face and an inner face, a first adhesive layer defining an inner face for contacting a can end, and a second adhesive layer disposed between the first polymeric layer and the second polymeric layer, or (ii) a can end label including a polymeric base film defining an outer face and an inner face, an adhesive layer extending along the inner face of the polymeric base film, and an overlam lacquer layer disposed on the polymeric base film. The method also comprises adhesively applying the selected can end label to the can such that the label overlies the tab and at least a portion of the circumferential sidewall of the can proximate the tab. The method also comprises prior to drinking the liquid from the can, removing the adhesively applied selected can end label from the can to thereby remove contaminants collected on the can end label proximate the tab.

As will be realized, the present subject matter is capable of other and different embodiments and its several details are capable of modifications in various respects, all without departing from the present subject matter. Accordingly, the drawings and description are to be regarded as illustrative and not restrictive.

### BRIEF DESCRIPTION OF THE DRAWINGS

FIG. 1 is a schematic perspective view of an embodiment of a can end label disposed on a liner, in accordance with the present subject matter.

FIG. 2 is a schematic cross sectional view of another embodiment can end label in accordance with the present subject matter.

FIG. 3 is a schematic cross sectional view of still another embodiment can end label in accordance with the present subject matter.

FIG. 4 is a schematic cross sectional view of yet another embodiment can end label in accordance with the present subject matter.

FIG. 5 is a schematic cross sectional view of yet another embodiment can end label in accordance with the present subject matter.

FIG. 6 is a perspective view of a can having an embodiment of a can end label attached to an end of the can in accordance with the present subject matter.

FIG. 7 is a schematic flowchart illustrating an embodiment of a method for forming a can end label and using the can end label in accordance with the present subject matter.

FIG. 8 is a perspective view of a can having another embodiment of a can end label attached to an end of the can in accordance with the present subject matter.

FIG. 9 is a schematic plan view of the can end label depicted in FIG. 8.

FIG. 10 is a perspective view of a can having another embodiment of a can end label attached to an end of the can in accordance with the present subject matter.

FIG. 11 is a perspective view of a can having another embodiment of a can end label attached to an end of the can in accordance with the present subject matter.

FIG. 12 is a perspective view of a can having another embodiment of a can end label attached to an end of the can in accordance with the present subject matter.

### DETAILED DESCRIPTION OF THE EMBODIMENTS

The present subject matter provides various can end labels and label assemblies. The subject matter also provides methods of forming the can end labels and using the can end labels. The subject matter additionally provides cans or other containers having one or more labels as described herein, removably attached to one or both ends of the can.

Although various uses and applications are contemplated for the can end labels, typically such labels are applied to a can by a beverage supplier or distributor or other party after filling and sealing of the can. The labels are visible at a point of sale or retail offering of the canned beverage or other product. Prior to opening of a can such as by a consumer, the label is easily removed from the can to thereby expose the tab portion or other opening provision along the can end.

Generally, the various embodiment can end labels comprise one or more polymeric “overlam” or base film layers, and one or more adhesive layers. The can end labels may in certain embodiments also comprise an overcoat or topcoat as described in greater detail herein. In certain embodiments, the can end labels include a configured inner face which corresponds to the topography or contour of the external surface of the can end that will receive the label. The term “configured” refers to a can end label having a shape and particularly along an inner face or inner surface of the label, that corresponds to the contour of the exterior surface of the can end which will receive the can end label. As will be appreciated, nearly all cans with opening provisions include an outwardly extending tab portion which at least initially extends along and is spaced from the exterior surface of the can end. Can ends may also include one or more outwardly extending projections and/or one or more recessed regions or depressions in the can end. Upon appropriately positioning a can end label with a configured inner face, and applying the can end label to the can end such that the inner face of the can end label is directed toward and contacting the exterior surface of the can end, the can end label is thus fittingly retained along the can end. The outwardly extending opening tab is received within a region of the configured can end label. That region is sized and shaped to fittingly receive and engage the can end tab. Although not wishing to be bound to any particular theory, it is believed that fittingly engaging a can end label as described herein with the contour of the can end of interest in conjunction with the use of a pressure sensitive adhesive, enables the label to be sufficiently adhered to the can end, be easily removable by a consumer, and not become prematurely separated prior to opening of the can.

The various embodiment can end labels can be transparent, translucent, or opaque. The labels can include one or more first regions that are transparent, translucent, or opaque; and one or more second regions that are different from the first regions and which are transparent, translucent, or opaque. In certain versions of the can end labels, the labels receive coloring, indicia, and/or designs to provide information or improved aesthetics to consumers. A wide array of printing materials, inks, pigments, and the like can be incorporated in the can end labels as described in greater detail herein.

A variety of techniques can be used to form one or more receiving regions in a can end label and/or form a configured can end label in accordance with certain methods of the present subject matter. A particular method of forming a configured can end label is by providing a die, stamp, or other member having an outer surface that matches or corresponds to the external surface of the can end of interest. The die is then urged in contact with a can end label, and particularly concurrently with application of pressure and/or heat to thereby form a can end label having a configured inner face. Thus, in certain embodiments the can end labels are thermoformed to exhibit the desired contour corresponding to the profile of the can end of interest. Although in certain embodiments, a configured can end label is formed by thermoforming, it is to be understood that the subject matter includes other strategies for forming configured can end labels. Furthermore, the present subject matter also includes can end labels that are not configured or otherwise shaped to match the three-dimensional contour of a can end. Instead, materials having suitable characteristics such as sufficient flexibility can be selected for the can end and thereby avoid any configuring or thermoforming operations. These and other aspects of the various embodiment can end labels, and their manufacture and use, are described herein.

### Overlam or Base Film

A wide array of materials can be used for the polymeric sheet(s) or film(s) which are used to form the can end labels of interest. As noted, in certain embodiments, the can end label is configured by thermoforming. Thus, for such can end labels, the polymeric films or sheets should be thermoformable. For example, polymeric films or sheets made from standard thermoformable materials and their blends such as polystyrene (PS), poly(ethylene terephthalate) (PET), poly(ethylene terephthalate glycol) (PETG), acrylic polymers, polycarbonates, polyethylene or other polyolefins, polyamides or nylons, or other polymers and combinations thereof typically used in thermoforming in applications such as trays, food/vegetable packages, cups, decorative or functional items, etc. are all suitable for the various embodiment can end labels and associated methods of forming. In particular, the materials use for the polymeric film(s) or layer(s) in the can end labels are polyethylenes, polyamides, or combinations thereof.

Additional specific examples of polymeric materials suitable for the sheet or film to be thermoformed include polyethylene and modified polyethylene. When thermoforming polyethylene, high performance nucleating agents may be used to improve speed, physical properties and aesthetics. And, various clarifying agents can be included in the polymeric material to provide clarity approaching that of glass and amorphous polymers. High performance nucleating agents can improve the quality of extruded polyethylene sheet feedstock. Further, clarifying agents for polyethylene enable this polymer to replace polystyrene and poly(ethylene terephthalate) in certain applications.

Homopolymer polyethylene is widely used in sheet extrusion and thermoforming applications because of its stiffness, clarity and cost effectiveness. Random copolymer polyethylene may be used to provide even higher levels of clarity and gloss and better cold temperature impact properties. From an environmental standpoint, polyethylene's relatively low density helps reduce the amount of material needed as well as overall packaging weight, which helps minimize landfilling and reduce fuel usage during shipping. Polyethylene also has a low carbon footprint, as a result of fewer emissions released during manufacture. Polyethylene is easily recycled in existing waste management systems, allowing the material to be reused indefinitely. In addition, polyethylene is generally free from undesirable side effects during recycling, such as crosslinking and forming a gel, or outgassing.

In addition, or instead of polymeric materials for the sheet(s) or films, the present subject matter includes the use of certain paper-based materials. For example, paper-based materials formed primarily from renewable resources are believed to also be suitable candidates for use in the various can end labels.

Furthermore, various composite materials can be used in the can end labels such as paper-based materials coated or coextruded with polymeric materials and in particular, polymer barrier materials such as polyethylene (PE) and ethylene vinyl alcohol (EVOH). Composite materials can include polymeric material(s), paper-based materials(s), metal(s) and alloy(s) which can for example be in the form of foils, and combinations thereof.

The material(s) forming the sheet(s) or film(s) of the can end labels can also include one or more additives. For example, various structural additives could be included such as fibrous high tensile strength materials. Agents providing certain barrier properties such as oxygen or water permeability can be included. Density adjusting agents, coloring agents, environmental protective agents such as for UV protection, and other agents for imparting particular properties or characteristics to the article can be used in the material of the can end label.

The sheet or film which forms the can end labels of interest can be of a single or monolayer, or can comprise multiple layers. For multilayer assemblies, the layers may be formed from different materials or from the same materials. In addition, it is contemplated that a variety of coatings and/or functional additives can be included in the sheet or film which forms the can end labels of interest. It is also contemplated that a wide array of provisions could be included such as assemblies that provide resealing or closure function, tamper indicators, and the like.

Another characteristic of the material selected for use in the can end label is that the material not tear, rip, or fracture during thermoforming or forming of the configured inner face. This characteristic also depends upon the particular thermoforming process and configuration of the thermoforming mold and surface. It will be appreciated by those skilled in the art of thermoforming that in many if not most thermoforming operations, the material is stretched, drawn, and/or expanded in one or more directions. This occurs as a result of the material deforming as it adopts the contour and/or configuration of the thermoforming surface.

As noted, polyethylene is suitable for use in many of the embodiments, however, other polyolefins can be used. The polyolefins used in the particular embodiment label assemblies can include a wide array of polyolefins known in the art. The polyolefin may be a homopolymer or a copolymer. The olefins which may be used to prepare the polyolefins include those having from about 2 to about 10, or from 2 to about 8, or from about 2 to about 4 carbon atoms. Examples of useful olefins include ethylene, propylene, butylene, methyl-pentene, hexene, octene, etc. In certain embodiments, the polyolefin is a homopolymer or copolymer derived of ethylene, propylene or butylene. In one embodiment, the polyolefin is an ethylene homopolymer or an ethylene copolymer. The copolymer is prepared from ethylene, propylene, or butylene and an olefin having from about 3 to about 100 or from about 4 to about 30 carbon atoms. In one embodiment, the olefin has from about 3 to about 12, or from about 4 to about 10 carbon atoms. In another embodiment, the olefin has from about 10 to about 100, or from about 12 to about 30 carbon atoms. In one embodiment, the olefin used to prepare the copolymer is an alpha-olefin. Examples of useful olefins include propylene, butylene, pentene, 4-methyl-1-pentene, hexene, heptene, octene, nonene, decene, undecene, dodecene, tetradecene, hexadecene, octadecene, and docosene. Typically, the olefin is present in an amount from about 1% up to about 50%, or from about 5% to about 30%, or from about 7% up to about 25% by mole. Examples of copolymers of ethylene include ethylene/propylene copolymers, ethylene/butylene copolymers, ethylene/hexene copolymers, ethylene/octene copolymers and ethylene/dodecene copolymers of ethylene and olefins, such as alpha-olefins are disclosed in U.S. Pat. No. 5,475,075, issued to Brant et al, and U.S. Pat. No. 5,530,054, issued to Tse et al. These patents are incorporated by reference for their disclosure of ethylene olefins and processes for making the same. Preferably, the polyolefin is polyethylene.

As noted, in certain embodiments, the can end labels include one or more polyamides. The polyamides used in particular embodiment can end label assemblies can include a range of polyamides. For example, useful polyamide resins include those commercially available from, for example, Union Camp of Wayne, N.J. under the UNI-REZ product line, and dimer-based polyamide resins available from Bostik, Emery, Fuller, Henkel (under the VERSAMID product line). Other suitable polyamides include those produced by condensing dimerized vegetable acids with hexamethylene diamine. It is also contemplated to utilize one or more aliphatic nylons such as nylon-MXD6 which is a generic name for a range of polyamides produced from xylenediamine (MXDA).

It is also contemplated that certain embodiment can end label assemblies can include one or more tie layers (not shown) disposed between various film layers and/or disposed on either of both faces of the base film layer. Depending on the particular polymeric materials used, in some embodiments, it is advantageous to extrude, simultaneously, one or more charges of material which become “tie” layers between coextruded layers. In particular, where two layers of material would not otherwise sufficiently adhere or bond to each other when coextruded, a “tie” layer is coextruded with and between the two layers, to hold them together in a substantially permanent unitary state. For example, nylon 6 and polyethylene can be coextruded to form a substantially permanent, unitary coextrudate by simultaneously extruding nylon 6, polyethylene, and a polymer having good affinity for both materials, such as a modified polyethylene or an ethylene vinyl acetate copolymer. Such a polymer becomes a “tie” layer between the nylon 6 and polyethylene layers. In general, the choice of “tie” layer material depends, at least in part, on various properties of the materials to be joined, or “tied,” together, including, for example, the materials' polar vs. nonpolar nature, modulus, flow properties, etc.

As noted, it is also contemplated that certain embodiment can end label assemblies may comprise one or more oxygen barriers or other films. A particular example of an oxygen barrier used in film assemblies is a layer including ethylene vinyl alcohol (EVOH). Instead of or in addition to an oxygen barrier, the particular film assemblies may also comprise one or more barriers for reducing or preventing passage or migration or other agents or chemical species. For example, in certain applications, it may be desired to include one or more layers that reduce or prevent the migration of water vapor or moisture. Furthermore, certain versions of the labels and label assemblies include barrier layers against oxygen, carbon dioxide, aromas/odors, moisture, oils, chemicals, and/or any combination thereof. Representative barrier materials include, but are not limited to, nylon (all types), nylon-MXD6, EVOH, PVOH, G-polymer, acrylonitrile methyl acrylate (ANMA) such as commercially available under the designation BAREX, cyclic olefin copolymers (COC), cyclic olefin polymers (COP), polyepichlorohydrin (ECO) polymers, liquid crystal polymers (LCP), polyglycolic acid polymers (PGA) such as those available commercially under the designation KUREDUX from Kureha Corporation, and poly (methyl methacrylate) (PMMA). A wide range of barrier coating technologies are also commercially available such as those under the designation NANOLOK from Inmat Inc.; NANOSEAL from Nanopack Inc.; and GOSHENOL from Nippon Gosher which are all PVOH-based materials. In addition, SiOX materials from Ceramis, which is a silicon dioxide layer applied by liquid-vapor deposition can be used. In addition, whey-based coatings such as those available from Wheylayer could also possibly be used. Barrier coatings formed by vacuum metallization can also be included in certain embodiments of the present subject matter.

### Adhesives

In certain embodiments, the can end label is attached to the can end by use of an adhesive that can withstand the thermoforming conditions and retain its adhesive properties at the thermoforming temperatures and draw magnitudes. Non-limiting examples of such adhesives include solvent based adhesives, and UV and/or thermally curable epoxy and/or acrylic or rubber adhesives which are designed to endure these harsh processing conditions. For a successful operation, in addition to the adhesive properties at high temperatures, viscosity of the adhesive is particularly chosen such that the adhesive will not become fluid at the thermoforming temperature and flow out from the label. In certain versions, the adhesive is a heat activated adhesive which is non-tacky at temperatures below about 160° C., and which is tacky and hence activated at temperatures greater than about 160° C., such as within a temperature range of from about 160° C. to about 200° C. In other embodiments, one or more pressure sensitive adhesives can be used.

### Overlam Lacquer

In certain embodiments, one or more layers of an overlam lacquer can be utilized as an outermost layer of the can end label. Typically, an overlam lacquer is applied as a liquid by spraying or coating to a can end label intermediate. The overlam lacquer then dries to form a solid layer. It is also contemplated to apply the overlam lacquer to a can end label after application to a can end.

A wide array of lacquer compositions are known in the art. Representative examples of such compositions include but are not limited to water-based lacquers that set by oxidation and polymerization such as urushiol-based lacquers, solvent-based lacquers such as nitrocellulose lacquers, and lacquers that are set by polymerization such as acrylic lacquers. Acrylic lacquers are generally useful due to their relatively fast drying time.

### Release Liner

A silicone release layer and corresponding liner can be provided on the exposed underside of the adhesive layer in the label assemblies.

### Printing

The various embodiment can end labels can be printed with one or more ink(s) prior to application or attachment to the can end. The ink, similar to the adhesive, exhibits appropriate characteristics such that the ink can withstand high thermoforming temperature(s) and the required draw magnitudes. If the ink cannot stretch with the label, the ink will potentially crack or fracture, and will have an unacceptable appearance. After stretching, the ink should not excessively lose its opacity as the quality of the printed material may not be acceptable. For example, inks formulated with polyurethanes or similar elastic polymers in their compositions are suitable materials for such an application. The incorporation of polyurethane in the ink composition generally allows stretching of the ink. The amount or percentage of polyurethane or other similar elastic polymer component in the ink formulation can most likely be correlated to the amount of stretch that the can end label endures. Non-limiting examples of preferred inks include LIOVALUE and AQUALIONA inks from Toyo Ink Company of Japan. These inks have been developed for packaging applications where the printed (and laminated) package containing food is sterilized at elevated temperatures of from about 121° C. (250° F.) to about 135° C. (275° F.). Similar inks that are designed for package boiling applications may also be suitable. In many applications, it is useful to utilize solvent inks designed for thermoforming. A particular new low viscosity oligomer designated as CN2285 from Sartomer Company, may in certain applications be used in a UV flexo ink. This oligomer can be used in applications in which high deformation occurs. The amount of pigment in the ink formulation and the required stretch magnitude of the label during thermoforming or configuring of the can end label are factors affecting print quality and opacity. Metallic inks containing polyurethane may also prove advantageous in providing prints with high gloss. Other materials and ink formulations known by those skilled in the art may also be utilized.

The labels are typically formed to exhibit graphics. Graphics can include for example, designs, indicia, markings, text, or patterns. The graphics can be incorporated in or upon the label in nearly any fashion. As described in greater detail herein, the graphics are formed by printing one or more inks on the label.

The graphics of the printed label may distort during the stretching stage of the thermoforming or configuring process. This distortion may therefore need to be accounted for when designing and constructing a printing cylinder or plate in anticipation of printing. Particularly, a distortion printing process that compensates for the expansion that the label will undergo during the thermoforming process is used. In one approach, the stretch magnitude at various locations of a thermoformed can end label is first determined. A grid patterned printed label facilitates distortion measurements at various locations on the formed piece, similar to a method described by Marcinkowski, Stanley, Michael, et al. in International Publication WO 2008/111000 A1. The distortion profile along with an accurate measure of thickness variation at various part locations are parameters typically used for print cylinder or plate design in order to print the graphics “distortedly”. Upon stretching of the printed can end label during thermoforming, the graphics of the finished label will then appear normal. Because stretch magnitudes differ from one application or object to another, each label may need its own “distortion” printing depending upon its material, location on the finished article, and thermoforming operation.

Printing on the can end label can be performed in nearly any manner. Although conventional printing techniques such as offset, flexographic, and gravure printing can be used, digital printing processes can be used for forming the desired markings, indicia, text, patterns, and/or designs on the label especially if the inks used in digital printing have the desired stretch characteristics. These are collectively referred to herein as “visual designs.” Digital printing is performed by an electronic controller or processer that stores information as to the subject matter to be printed, and one or more printheads or other components that form the desired markings, indicia, text, patterns, and/or designs, i.e. the visual designs. As previously noted, if desired, the visual designs may be initially formed or deposited in a distorted fashion. After thermoforming or configuring of the can end labels, such distorted visual designs appear in their intended manner.

### Particular can End Labels

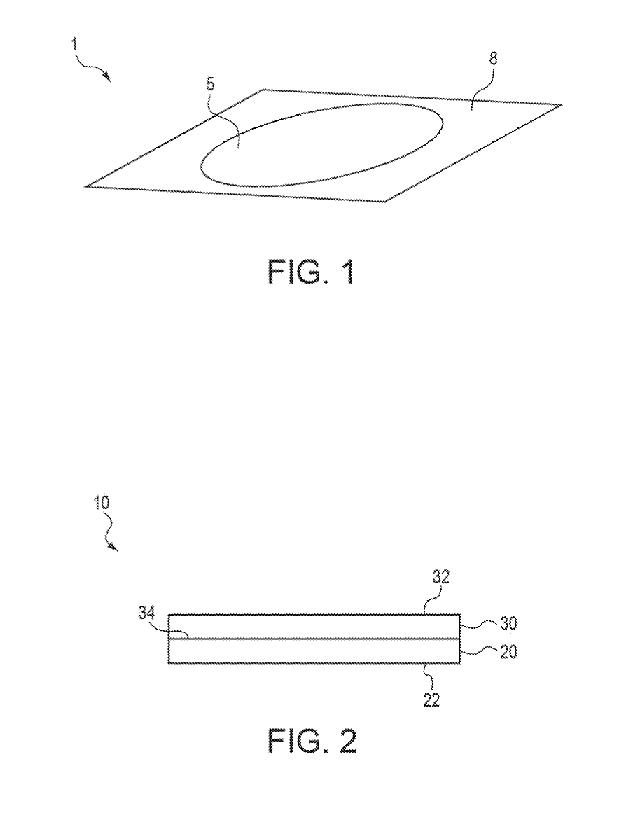

FIG. 1 is a schematic perspective view of a particular embodiment can end label assembly 1 comprising a can end label 5 releasably disposed on a liner 8. Although a single can end label 5 is illustrated, it will be appreciated that the present subject matter includes collections of multiple label assemblies and particularly multiple can end labels disposed on a common liner.

FIG. 2 is a schematic cross sectional view of another embodiment can end label 10. The label 10 comprises a polymeric film layer 30 defining an outer face 32 and an oppositely directed inner face 34. Disposed along the inner face 34 is an adhesive layer 20 defining an inner face 22 for contacting a can end. When referring to outer faces or surfaces, and inner faces or surfaces of the can end labels the following convention is used. The “outer face” or “outer surface” of the can end label or layer thereof is the face or surface which is directed away from the can after application of the can end label to a can end. The “inner face” or “inner surface” of the can end label or layer thereof is the face or surface which is directed toward the can end after application of the can end label to a can end.

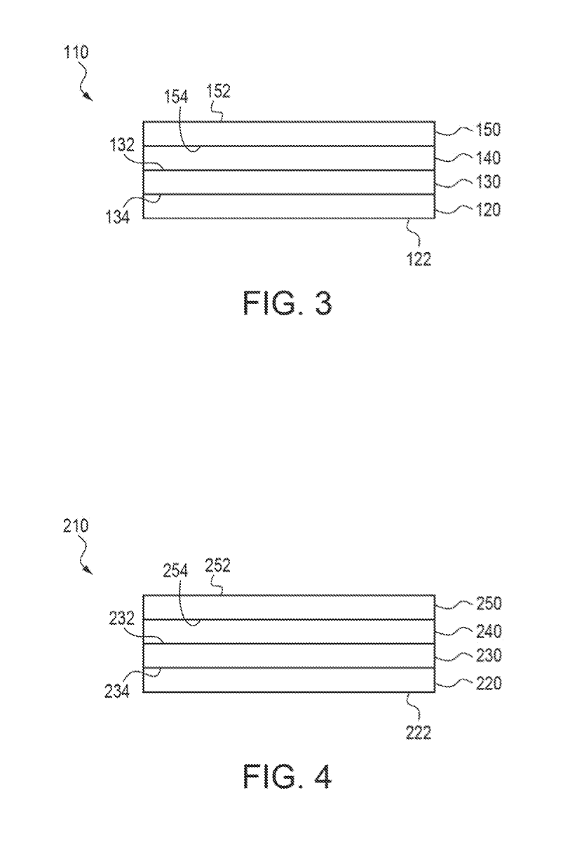

FIG. 3 is a schematic cross sectional view of another embodiment can end label 110. The label 110 comprises a first polymeric base film 130 defining outer and inner surfaces 132, 134 respectively; and an overlam polymeric film 150 defining outer and inner surfaces 152, 154 respectively. The label 110 also comprises two adhesive layers. A first adhesive layer 120 which is a pressure sensitive adhesive, is disposed along the inner face 134 of the base film 130. The adhesive layer 120 defines an inner face 122 for contacting a can end. A second adhesive layer 140 which is a pressure sensitive adhesive is disposed between the overlam film 150 and the base film 130. Specifically, the second adhesive layer 140 is disposed between the outer surface 132 of the base film 130 and the inner surface 154 of the overlam film 150.

FIG. 4 is a schematic cross sectional view of another embodiment can end label 210. The label 210 comprises a first polymeric base film 230 defining outer and inner surfaces 232, 234 respectively; and an overlam polymeric film 250 defining outer and inner surfaces 252, 254 respectively. The label 210 also comprises two adhesive layers. A first adhesive layer 220 which is a pressure sensitive adhesive, is disposed along the inner face 234 of the base film 230. The adhesive layer 220 defines an inner face 222 for contacting a can end. A second adhesive layer 240 which is an overlam adhesive is disposed between the overlam film 250 and the base film 230. Specifically, the second adhesive layer 240 is disposed between the outer surface 232 of the base film 230 and the inner surface 254 of the overlam film 250.

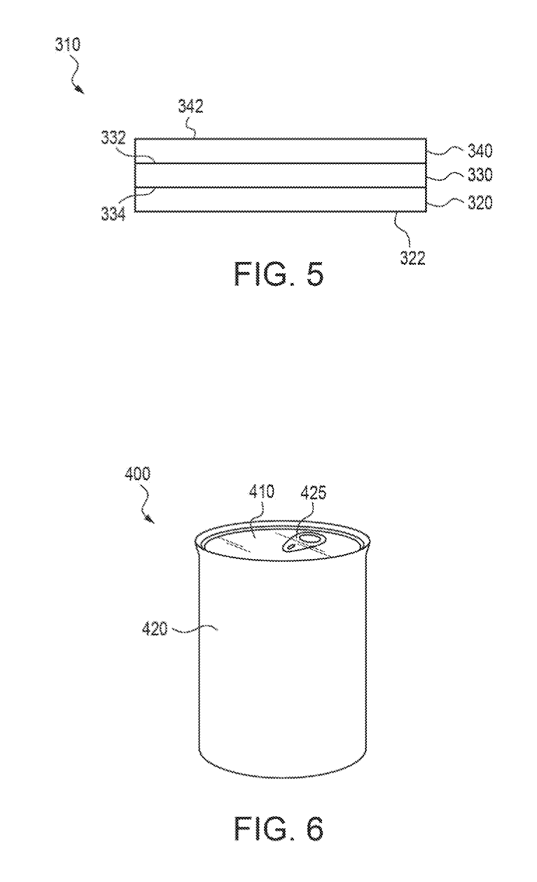

FIG. 5 is a schematic cross sectional view of another embodiment can end label 310. The label 310 comprises a polymeric base film 330 defining outer and inner faces 332, 334 respectively. The label 310 also comprises an adhesive layer 320 which is a pressure sensitive adhesive. The adhesive layer 320 defines an inner adhesive surface 322 for contacting a can end. The label 310 also comprises an overlam polymeric resin layer 340 which is a transparent or substantially so, transparent lacquer. The overlam layer 340 defines an outer face 342.

Several specific can end label constructions are summarized below in Tables 1-3 as follows.

TABLE 1
Label 110

| Layer ID | Layer Description |
|---|---|
| 150 | Overlam Film (outermost layer) |
| 140 | Pressure Sensitive Adhesive |
| 130 | Base Film |
| 120 | Pressure Sensitive Adhesive |

Layers 150 and 130 are formed from the same material. Typically, this material is a formable polymeric material such as polyethylene and/or polyamide. And, layers 140 and 120 are also formed from the same pressure sensitive adhesive. Print may be deposited on layer 130.

TABLE 2
Label 210

| Layer ID | Layer Description |
|---|---|
| 250 | Overlam Film (outermost layer) |
| 240 | Overlam Adhesive |
| 230 | Base Film |
| 220 | Pressure Sensitive Adhesive |

Layers 250 and 230 are formed from the same polymeric material, e.g. polyethylene and/or polyamide. The adhesives of layers 240 and 220 are typically different. Print may be deposited on layer 230.

TABLE 3
Label 310

| Layer ID | Layer Description |
|---|---|
| 340 | Overlam Lacquer (outer layer) |
| 330 | Base Film |
| 320 | Pressure Sensitive Adhesive |

Layer 330 is formed from a formable polymeric material as previously noted. Print may be applied to layer 320.

FIG. 6 illustrates a can 420 having an embodiment of a can end label 410 disposed on and covering an end of the can. Although the can end label 410 is depicted as being transparent and thereby allowing an opening tab 425 to be seen through the label 410, it will be appreciated that the present subject matter includes can end labels that are opaque or which otherwise do not allow viewing of the can end through the label. It will be appreciated that the tab is removable and allows a user to access or dispense the contents of the can. Generally, the cans for which the various embodiment can end labels are for use with, include two opposite ends with at least one sidewall extending between the ends. Typically, the ends are circular and the sidewall is circumferential. However, the present subject matter includes a wide array of shapes and configurations for the cans.

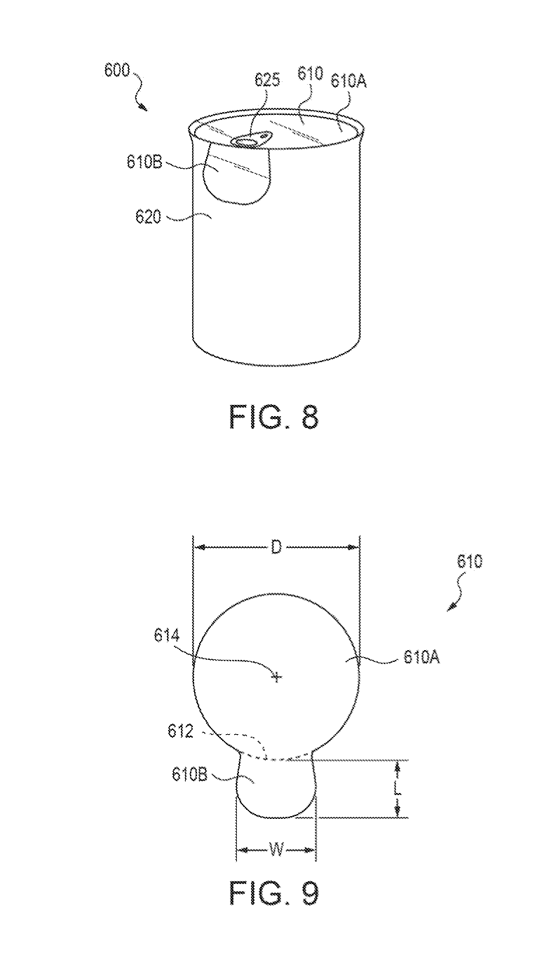

FIG. 8 illustrates a labeled can 600 or other similar container having an embodiment of a can end label 610 disposed on and covering an end of a can 620. As previously noted, although the can end label 610 is shown as being transparent and thereby allowing an opening tab 625 to be viewed through the label 610, it will be understood that the present subject matter includes can end labels that are opaque or nontransparent or which otherwise do not allow viewing of the can end through the label. In the can end label 610 and can 620 having the label 610 releasably adhered thereon, it will be noted that the label 610 includes an end portion 610A and an adjacent and contiguous sidewall portion 610B. The end portion 610A is disposed on and generally overlies an end wall of the can 620. The sidewall portion 610B of the label 610 is disposed on and contacts at least a portion of the circumferential sidewall of the can 620. Both the end portion 610A and the sidewall portion 610B are adhesively yet releasably attached to the respective regions of the can 620. The sidewall portion 610B of the label 610 is oriented with respect to the can 620 such that the sidewall portion 610B is proximate the tab 625 of the can 620. Specifically, the sidewall portion 610B covers a region of the sidewall of the can 620 that is contacted by a consumer's mouth when drinking the contents of the can 620. Thus, it will be appreciated that the label 610 provides a convenient means for reducing the potential of a consumer contacting a contaminated surface of a can. Prior to drinking from the can, the consumer removes the label 610 from the can, and thereby exposes clean surfaces of the can.

FIG. 9 is a schematic plan view of the can end label 610 depicted in FIG. 8. As previously noted, the can end label 610 includes an end portion 610A and a sidewall portion 610B. The portions 610A and 610B are adjacent to one another and define a draping region 612 having a generally arcuate configuration. It will be understood that upon application of the can end label 610 to a can of interest, the draping region 612 generally overlies and contacts an upwardly extending ridge or “lip” that is included along an upper end of many beverage cans. The end portion 610A of the label 610 is generally circular in shape and defines a center 614. The end portion 610A is sized so that its diameter shown as dimension D in FIG. 9 is the same or slightly less than the diameter of the can of interest. Dimensions of beverage cans vary, however many beverage cans in the United States have a diameter as measured at a can end or lip of 2.13 inches (5.41 cm). Thus, for such cans, the diameter of the label 610 can be from about 2.1 inches to about 1.5 inches (5.3 cm to 3.8 cm) for example. It will be understood that in no way is the present subject matter limited to any of these representative dimensions.

The can end label 610 also includes the sidewall portion 610B having a length dimension depicted as L in FIG. 9. The length L may be any length up to the height of the can of interest. However, for many applications, the length is from about 10% to 100% of the dimension D. However, the present subject matter includes can end labels similar to label 610 having lengths L that are greater than the D dimension.

The sidewall portion 610B of the label 610 also exhibits a width dimension W as shown in FIG. 9 which is taken across the maximum width span of the portion 610B. Although the width W of the sidewall portion 610B can be nearly any value up to the circumference of the can of interest, typically the width is from about 10% to 100% of the dimension D. It will be understood that the size and shape of the sidewall portion 610B is generally such so as to provide a clean or fresh surface region of the can side upon removal of the can label 610 from the can 620. The size and shape of the label 610 and particularly the sidewall portion 610B can also be such to accommodate graphics, text, or branding information as desired.

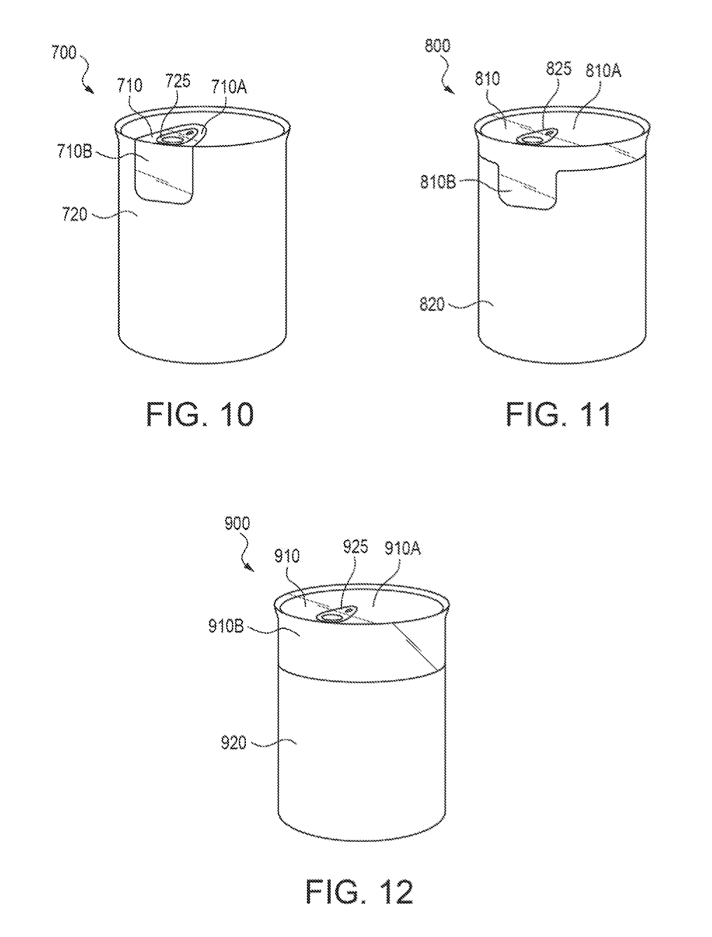

FIG. 10 illustrates a labeled can 700 comprising a can 720 or other similar container having an embodiment of a can end label 710 disposed on and covering an end of the can. As previously noted, although the can end label 710 is shown as being transparent and thereby allowing an opening tab 725 to be viewed through the label 710, it will be understood that the present subject matter includes can end labels that are opaque or nontransparent or which otherwise do not allow viewing of the can end through the label. In the can end label 710 and can 720 having the label 710 releasably adhered thereon, it will be noted that the label 710 includes an end portion 710A and an adjacent and contiguous sidewall portion 710B. The end portion 710A is disposed on and generally overlies an end wall of the can 720. In this version, the end portion 710A is significantly smaller in surface area as compared to the can end. The sidewall portion 710B of the label 710 is disposed on and contacts at least a portion of the circumferential sidewall of the can 720. Both the end portion 710A and the sidewall portion 710B are adhesively yet releasably attached to the respective regions of the can 720. The sidewall portion 710B of the label 710 is oriented with respect to the can 720 such that the sidewall portion is proximate the tab 725 of the can 720. Specifically, the sidewall portion 710B covers a region of the sidewall of the can 720 that is contacted by a consumer's mouth when drinking the contents of the can 720. Thus, it will be appreciated that the label 710 provides a convenient means for reducing the potential of a consumer contacting a contaminated surface of a can because prior to drinking from the can, the consumer removes the label 710 from the can, thereby exposing clean surfaces of the can.

FIG. 11 illustrates a labeled can 800 comprising a can 820 or other similar container having an embodiment of a can end label 810 disposed on and covering an end of the can. As previously noted, although the can end label 810 is shown as being transparent and thereby allowing an opening tab 825 to be viewed through the label 810, it will be understood that the present subject matter includes can end labels that are opaque or nontransparent or which otherwise do not allow viewing of the can end through the label. In the can end label 810 and can 820 having the label 810 releasably adhered thereon, it will be noted that the label 810 includes an end portion 810A and an adjacent and contiguous sidewall portion 810B. The end portion 810A is disposed on and generally overlies an end wall of the can 820. The sidewall portion 810B of the label 810 is disposed on and contacts at least a portion of the circumferential sidewall of the can 820. Both the end portion 810A and the sidewall portion 810B are adhesively yet releasably attached to the respective regions of the can 820. In this version, the sidewall portion 810B of the label 810 includes a band that generally extends around the circumference of the can, or substantially so. The sidewall portion 810B is oriented with respect to the can 820 such that a downwardly extending portion of the sidewall portion is proximate the tab 825 of the can 820. Specifically, the sidewall portion 810B covers a region of the sidewall of the can 820 that is contacted by a consumer's mouth when drinking the contents of the can 820. Thus, it will be appreciated that the label 810 provides a convenient means for reducing the potential of a consumer contacting a contaminated surface of a can because prior to drinking from the can, the consumer removes the label 810 from the can, thereby exposing clean surfaces of the can.

As depicted in FIG. 11, the sidewall portion 810B of the can end label 810 extends around or at least around a majority portion of the circumference of the can. This configuration may be useful for providing branding information or other text that is visible along the can regardless of the rotational orientation of the can.

FIG. 12 illustrates a labeled can 900 comprising a can 920 or other similar container having an embodiment of a can end label 910 disposed on and covering an end of the can. As previously noted, although the can end label 910 is shown as being transparent and thereby allowing an opening tab 925 to be viewed through the label 910, it will be understood that the present subject matter includes can end labels that are opaque or nontransparent or which otherwise do not allow viewing of the can end through the label. In the can end label 910 and can 920 having the label 910 releasably adhered thereon, it will be noted that the label 910 includes an end portion 910A and an adjacent and contiguous sidewall portion 910B. The end portion 910A is disposed on and generally overlies an end wall of the can 920. The sidewall portion 910B of the label 910 is disposed on and contacts at least a portion of the circumferential sidewall of the can 920. Both the end portion 910A and the sidewall portion 910B are adhesively yet releasably attached to the respective regions of the can 920. The sidewall portion 910B covers a region of the sidewall of the can 920 that is contacted by a consumer's mouth when drinking the contents of the can 920. Thus, it will be appreciated that the label 910 provides a convenient means for reducing the potential of a consumer contacting a contaminated surface of a can because prior to drinking from the can, the consumer removes the label 910 from the can, thereby exposing clean surfaces of the can.

The can end label 910 differs from the previously described labels 610, 710, and 810 in that the label 910 is orientation-independent. That is, the sidewall portion 910B extends a distance along the can sidewall that is uniform around the can circumference. Thus, the label 910 can be applied to a can regardless of the rotational orientation of the can, i.e., and thus resulting location of the opening or tab along the can end.

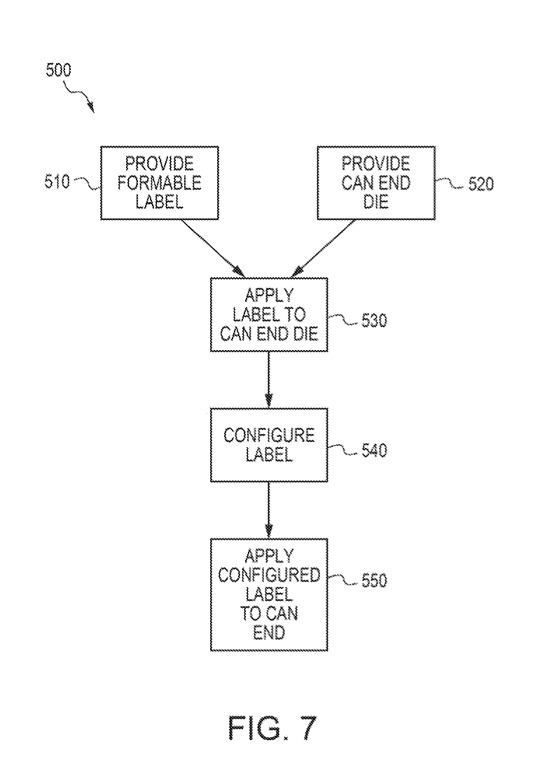

As noted, the present subject matter also provides various methods. Certain methods are related to forming the various embodiment can end labels and/or using the labels such as by attaching the labels to a can end. FIG. 7 is a schematic flowchart of a particular embodiment method 500 in accordance with the present subject matter. The method 500 comprises an operation 510 of providing a formable label. The label can have any of the constructions as described herein. In particular, the label includes at least one layer of adhesive along an inner face of the label. However, the subject matter includes methods in which one or more adhesive layers are applied after appropriately forming or configuring the label as described herein. In operation 510, particularly one of the previously described labels 5, 10, 110, 210, 310, 610, 710, 810, or 910 are provided.

The method 500 also comprises an operation 520 of providing a can end die. The die defines a contoured outer die surface that matches or corresponds to the outer surface of the can end including any opening tabs or other projections or recessions, of interest. The die is formed of nearly any suitable material typically used in the thermoforming arts for transferring a desired geometry to a polymeric receiving member or surface. In particular, the die is formed from metal.

The method 500 also comprises operation 530 in which the label is applied to the can end die. This involves contacting a face of the label, typically an inner face, to an external surface of the can end die. In a particular aspect, the die and/or associated equipment includes a plurality of apertures through which air may be drawn such as by a vacuum pump. Using such provisions, as the can end label is positioned into proximity with the die, the vacuum provisions transfer or at least assist in transfer of the label to the die surface. In certain embodiments, the vacuum provisions transfer the can end label from a liner directly to the die surface.

The method additionally comprises operation 540 in which the label is shaped or configured to match or correspond to the contour of the can end of interest. In particular, the contour or three-dimensional profile of the die surface is transferred to the can end label. Generally, operation 540 will involve application of heat and/or pressure as appropriate to suitably thermoform the can end label and form a configured can end label. Depending upon the particular processing equipment, it may be possible to essentially combine operations 530 and 540.

After completion of operation 540, a configured can end label is thus produced. Typically, the configured can end label will be non-planar. The configured can end label can be stored, stocked, or otherwise retained in a variety of forms such as on sheets of release liners or in rolled form. It is also contemplated that immediately after forming the configured can end label, the label can be applied onto a can end. This operation is depicted as operation 540 in FIG. 7. If using vacuum provisions for transferring and/or retaining a label onto a die, the vacuum provisions can in certain applications be appropriately operated to either release the can end label from the die or expel the can end label from the die. Release of the can end label is performed by discontinuing the region of reduced pressure on the die-side of the can end label. Expelling of the can end label can be performed by reversing the flow of air through the die whereby air flows outward from the face of the die, thereby dislodging and separating the can end label from the die face.

For configured can end labels having an adhesive layer disposed along their inner face, the configured can end labels are contacted with and applied to the can end(s) of interest. Typically, the adhesive layer serves to adhere the configured can end label to the can end.

It is also contemplated that an activatable adhesive may be used which is non-tacky prior to activation. During configuring or shaping of the can end label such as in operation 540, the adhesive is not activated. After operation 540, the adhesive is then activated to render the adhesive tacky.

The method 500 also comprises an operation 550 in which the configured can end label is applied to a can end. Generally, the operation involves positioning the can end label and can end close to one another and then contacting an exposed inner surface or face of the can end label to the can end. In certain versions, the exposed inner surface or face of the can end is that of an adhesive layer such as face 122 of label 110, face 222 of label 210, and face 322 of label 310 for example.

In the various methods described herein, thermoforming or configuring of a can end label has been described by contacting an inner face or inner surface of a can end label with a die. In these methods, the die features a surface that matches, is identical to, or is substantially identical to the external surface of the can end of interest including any projections, recessions, or the like. The present subject matter also includes methods in which a die having a “negative” surface (or sometimes referred to as a “negative die”) is used. A negative die or negative impression provides a die surface that has a contour which is opposite that of the can end of interest. Thus for example, for a can end having an outwardly extending tab and a recessed region surrounding a scored opening region, a corresponding negative die would feature a recessed contour for the tab and a projecting region for the region surrounding the opening. An advantage of using a negative die is that when thermoforming or otherwise configuring a can end label, the die need not contact an inner face of the label which typically contains adhesive. Instead, the die contacts an outer face of the can end label.

The present subject matter also provides methods and techniques for reducing the potential for contamination from contacting an outer surface of a beverage can upon drinking a liquid from the can. As will be appreciated, outer surfaces of cans can become contaminated with dirt, debris, undesirable agents or substances, and/or microorganisms. After filling and sealing a can, the can is often exposed to a wide array of environments such as warehouse storage or truck or rail distribution. During such exposure surface regions of the can may collect dirt, debris, undesirable agents or compounds, and/or microorganisms. The contaminants can collect along areas or regions of the can which a user may contact. In particular, during drinking from the can, a user's lips or mouth may contact these areas or regions and thus also contact the contaminants. The present subject matter provides methods of reducing the potential for such contamination by applying a can end label as described herein to a can end and particularly over a tab and adjacent surface regions of the can. A particular surface region is a circumferential surface region of the can sidewall adjacent to the tab or can opening. The can end label is applied to a clean can such as after filling, sealing, and/or washing; and prior to collection of contaminants. A user, prior to drinking from the can, removes the can end label along with any contaminants residing on the label.

Although the present subject matter and its various embodiments have been described primarily with reference to a single label and/or a single sheet, it will be appreciated that the subject matter includes forming multiple can end labels on a single sheet. Thus, the subject matter includes operations in which multiple configured labels are formed by thermoforming a single labeled sheet. A single sheet can receive multiple labels, one or more labels being positioned at a region of the sheet identified for forming one or more can end labels. The partially or completely labeled sheet is then subjected to one or more thermoforming operations whereby a plurality of configured can end labels are formed.

The present subject matter can end labels can be used in association with cans or other similarly shaped containers having a wide array of opening or dispensing provisions. For example, the various can end labels can be used with cans having pull-tabs, stay-on-tabs, wide mouth openings, sustainable beverage ends as known in the art, press button cans having two or more precut openings which are sealed at a can end, and a full aperture end opening in which an entire end of a can is removed.

It will be understood that any one or more feature or component of one embodiment described herein can be combined with one or more other features or components of another embodiment. Thus, the present subject matter includes any and all combinations of components or features of the embodiments described herein.

Many other benefits will no doubt become apparent from future application and development of this technology.

All patents, published applications, and articles noted herein are hereby incorporated by reference in their entirety.

As described hereinabove, the present subject matter solves many problems associated with previous type devices and practices. However, it will be appreciated that various changes in the details, materials and arrangements of components or operations, which have been herein described and illustrated in order to explain the nature of the subject matter, may be made by those skilled in the art without departing from the principle and scope of the subject matter, as expressed in the appended claims.

What is claimed is:

1. A can end label comprising:
a first polymeric layer defining an outer face and an inner face;
a second polymeric layer defining an outer face and an inner face;
a first adhesive layer defining an inner face for contacting a can end; and
a second adhesive layer disposed between the first polymeric layer and the second polymeric layer.

2. The can end label of claim 1 wherein the first polymeric layer includes at least one of polyethylene and polyamide.

3. The can end label of claim 1 wherein the second polymeric layer includes at least one of polyethylene and polyamide.

4. The can end label of claim 1 wherein the first adhesive layer includes a pressure sensitive adhesive.

5. The can end label of claim 1 wherein the first adhesive layer includes an activatable adhesive.

6. The can end label of claim 5 wherein the activatable adhesive is activated and rendered tacky at a temperature greater than about 160° C.

7. The can end label of claim 1 further comprising:
at least one mark, indicia, text, pattern, and design disposed on the can end label.

8. The can end label of claim 7 wherein the at least one mark, indicia, text, pattern, and design is disposed on at least one of the first polymeric layer and the second polymeric layer.

9. The can end label of claim 1 wherein the can end label is configured.

10. The can end label of claim 9 wherein an inner face of the can end label is non-planar.

11. The can end label of claim 1 wherein the label includes an end portion sized and shaped to adhesively contact an end of a can of interest, and a sidewall portion configured to adhesively contact a circumferential surface region of the can of interest, the end portion of the label and the sidewall portion of the label adjacent and contiguous with each other.

12. A labeled can comprising:
a can defining a first end, a second end opposite from the first end, and at least one sidewall extending between the first and the second ends; and
a can end label as recited in claim 1 removably attached to at least one of the first end and the second end.

13. The labeled can of claim 12 further comprising a tab disposed between the first end and the can end label.

14. A can end label comprising:
a polymeric base film defining an outer face and an inner face;
an adhesive layer extending along the inner face of the polymeric base film; and
an overlam lacquer layer disposed on the polymeric base film.

15. The can end label of claim 14 wherein the base film includes at least one of polyethylene and polyamide.

16. The can end label of claim 14 wherein the adhesive layer includes a pressure sensitive adhesive.

17. The can end label of claim 14 wherein the adhesive layer includes an activatable adhesive.

18. The can end label of claim 17 wherein the activatable adhesive is activated and rendered tacky at a temperature greater than about 160° C.

19. The can end label of claim 14 further comprising:
at least one mark, indicia, text, pattern, and design disposed on the can end label.

20. The can end label of claim 14 wherein the can end label is configured.

21. The can end label of claim 20 wherein the can end label is non-planar.

22. The can end label of claim 14 wherein the label includes an end portion sized and shaped to adhesively contact an end of a can of interest, and a sidewall portion configured to adhesively contact a circumferential surface region of the can of interest, the end portion of the label and the sidewall portion of the label adjacent and contiguous with each other.

23. A labeled can comprising:
a can defining a first end, a second end opposite from the first end, and at least one sidewall extending between the first and the second ends; and
a can end label as recited in claim 14 removably attached to at least one of the first end and the second end.

24. The labeled can of claim 23 further comprising a tab disposed between the first end and the can end label.

25. A method of forming a can end label adapted for placement on a can end, the method comprising:
providing a can end label;
providing a can end die defining a contoured die surface corresponding to the can end of interest;
applying the can end label to the can end die; and
transferring a contour of the die surface to the can end label to thereby form a configured can end label adapted for placement on the can end.

26. The method of claim 25 wherein applying the can end label to the can end die is performed at least in part by vacuum provisions.

27. The method of claim 25 wherein transferring the contour of the die surface to the can end label is performed by thermoforming.

28. The method of claim 25 wherein the die surface is a positive die surface of the can end of interest.

29. The method of claim 25 wherein the die surface is a negative die surface of the can end of interest.

30. The method of claim 25 further comprising:
applying the configured can end label to the can end of interest.

31. The method of claim 30 wherein the can end label includes a layer of heat activated adhesive and the applying includes heating the can end label to thereby activate the adhesive and render the adhesive tacky.

32. A method for reducing potential of contamination from contacting an outer surface of a beverage can upon drinking a liquid from the can, the method comprising:
providing a sealed beverage can containing a liquid, the can including a circular end having a removable tab, and a circumferential sidewall;
selecting either (i) a can end label including a first polymeric layer defining an outer face and an inner face, a second polymeric layer defining an outer face and an inner face, a first adhesive layer defining an inner face for contacting a can end, and a second adhesive layer disposed between the first polymeric layer and the second polymeric layer, or (ii) a can end label including a polymeric base film defining an outer face and an inner face, an adhesive layer extending along the inner face of the polymeric base film, and an overlam lacquer layer disposed on the polymeric base film;
adhesively applying the selected can end label to the can such that the label overlies the tab and at least a portion of the circumferential sidewall of the can proximate the tab;
prior to drinking the liquid from the can, removing the adhesively applied selected can end label from the can to thereby remove contaminants collected on the can end label proximate the tab.

33. The method of claim 32 wherein the selected can end label includes at least one mark, indicia, text, pattern, and design visible upon adhesive application of the selected can end label to the can.

34. The method of claim 32 wherein prior to adhesively applying the selected can end label to the can, the can end label is configured for placement on the can end.
